(19) United States
(12) Patent Application Publication
(10) Pub. No.: US 2025/0373507 A1
(43) Pub. Date: Dec. 4, 2025

(54) COMMUNICATION DEVICES AND METHODS FOR MACHINE LEARNING MODEL MONITORING

(71) Applicant: SHENZHEN TCL NEW TECHNOLOGY CO., LTD., Shenzhen, Guangdong (CN)

(72) Inventor: Junrong GU, Shenzhen, Guangdong (CN)

(73) Assignee: SHENZHEN TCL NEW TECHNOLOGY CO., LTD., Shenzhen, Guangdong (CN)

(21) Appl. No.: 18/878,053

(22) PCT Filed: Sep. 30, 2022
(86) PCT No.: PCT/CN2022/123284

§ 371 Date: Dec. 22, 2024

(51) Int. Cl. H04L 41/16; H04B 7/06

(52) U.S. Cl. CPC H04L 41/16; H04B 7/0626

(57) ABSTRACT

A method for being configured with a machine learning (ML) model monitoring by at least one first node includes being provided with an assistant information by a second node, wherein the assistant information is used for the at least one first node and/or the second node to monitor a plurality of ML models having a common part.

### BACKGROUND OF DISCLOSURE

### 1. Field of the Disclosure

The present disclosure relates to the field of wireless communication systems, and more particularly, to communication devices and methods for machine learning (ML) model monitoring, for example, the present disclosure is related to the new study item description (SID) on AI/ML for new radio (NR) air interface of the Release18, which is established in 3rd generation partnership project (3GPP) radio access network (RAN) plenary meetings 94e in December 2022. The discussion is led by RAN1 and begins in May 2022. Particularly, the present disclosure is related to an enhanced channel state information (CSI) report feedback, beam management and/or positioning, wherein several ML models for CSI feedback can have a common CSI reconstruction part.

### 2. Description of the Related Art

The AI/ML is applied to the 3GPP RAN1. Several use cases are decided to be studied. They are respectively a CSI feedback enhancement, a beam management, and a positioning. As indicated in the 3GPP new SID, although specific AI/ML algorithms and models may be studied for evaluation purposes, AI/ML algorithms and models are implementation specific and are not expected to be specified. The ML model at first should be trained, then deployed. After deployment, the ML mode will enter inference stage. At inference stage, the ML models will be monitored to see whether the ML model works properly. Recently, the ML enhanced CSI feedback is under discussion by 3GPP RAN1. The ML enhanced CSI feedback compresses the CSI at the UE side, and recovers the CSI at the gNB side. The ML models for CSI feedback with a common CSI reconstruction part is mentioned in RAN 110 meeting. There are some issues on how to determine that there is a malfunction on the ML model for a UE and/or how to deactivate the common part of ML models with less signaling overhead. Furthermore, the activation and deactivation of the plurality of ML models with a common part need to be discussed.

Therefore, there is a need for communication devices and methods for machine learning (ML) model monitoring, which can solve the issues in the prior art, reduce a management of a plurality of ML models with a common part, provide methods of monitoring of a plurality of ML models with a common part, reduce system signaling overhead, provide a good communication performance, and/or provide high reliability.

### SUMMARY

An object of the present disclosure is to propose communication devices and methods for machine learning (ML) model monitoring, which can solve the issues in the prior art, ease the management of a plurality of ML models with a common part, provide methods of monitoring of a plurality of ML models with a common part, reduce system signaling overhead, provide a good communication performance, and/or provide high reliability.

In a first aspect of the present disclosure, a method for being configured with a machine learning (ML) model monitoring by at least one first node includes being provided with an assistant information by a second node, wherein the assistant information is used for the at least one first node and/or the second node to monitor a plurality of ML models having a common part.

In a second aspect of the present disclosure, a first node comprises a memory, a transceiver, and a processor coupled to the memory and the transceiver. The processor is configured to execute the above method.

In a third aspect of the present disclosure, a method for configuring an ML model monitoring performed by a second node includes configuring or providing an assistant information to a first node and at least one third node, wherein the assistant information is used for the second node and/or a first node and at least one third node to monitor a plurality of ML models having a common part.

In a fourth aspect of the present disclosure, a second node comprises a memory, a transceiver, and a processor coupled to the memory and the transceiver. The processor is configured to execute the above method.

In a fifth aspect of the present disclosure, a non-transitory machine-readable storage medium has stored thereon instructions that, when executed by a computer, cause the computer to perform the above method.

In a sixth aspect of the present disclosure, a chip includes a processor, configured to call and run a computer program stored in a memory, to cause a device in which the chip is installed to execute the above method.

In a seventh aspect of the present disclosure, a computer readable storage medium, in which a computer program is stored, causes a computer to execute the above method.

In an eighth aspect of the present disclosure, a computer program product includes a computer program, and the computer program causes a computer to execute the above method.

In a ninth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating an example of a basic auto-encoder model for enhanced CSI feedback according to an embodiment of the present disclosure.

FIG. 2 is a block diagram of one or more user equipments (UEs) and a base station (e.g., gNB) of communication in a communication network system according to an embodiment of the present disclosure.

FIG. 3 is a flowchart illustrating a wireless communication for providing the assistant information by a second node or artificial intelligence (AI)/machine learning (ML) performed by a UE according to an embodiment of the present disclosure.

FIG. 4 is a flowchart illustrating a wireless communication for configuring the UE with assistant information for artificial intelligence (AI)/machine learning (ML) performed by a base station according to an embodiment of the present disclosure.

FIG. 5 is a schematic diagram illustrating an example of a basic auto-encoder model for enhanced CSI feedback according to an embodiment of the present disclosure.

FIG. 6 is a schematic diagram illustrating an example of a functional framework of RAN intelligence according to an embodiment of the present disclosure.

FIG. 7 is a schematic diagram illustrating an example of two UEs with corresponding encoder share a common decoder at the gNB side according to an embodiment of the present disclosure.

FIG. 8 is a schematic diagram illustrating an example of the monitoring of a two-sided model, which has a common part CSI reconstruction part according to an embodiment of the present disclosure.

FIG. 9 is a flowchart illustrating an example of monitoring two-sided models, which has a common part CSI reconstruction part according to an embodiment of the present disclosure.

FIG. 10 is a block diagram of a communication device such as UE according to an embodiment of the present disclosure.

FIG. 11 is a block diagram of a communication device such as gNB according to an embodiment of the present disclosure.

FIG. 12 is a block diagram of a general framework for ML/AI for NR air interface according to an embodiment of the present disclosure.

FIG. 13 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The AI/ML is introduced into a physical (PHY) layer and a medium access control (MAC) layer, to enhance the system performance. Several use cases are decided to be studied in 3GPP RAN1. They are respectively the CSI feedback compression, the beam management, and the positioning. The ML learning models can be trained either online or offline.

For a machine learning model, it should be trained at first. The training can be performed by a node, which can be a gNB, a UE, or a third node. The training can be online training or offline training. After the ML model is trained, it will be deployed. For enhance CSI feedback, the ML model is a two-sided model, which will be deploy at a UE and a gNB, respectively. The CSI models will be monitored to see whether is works properly.

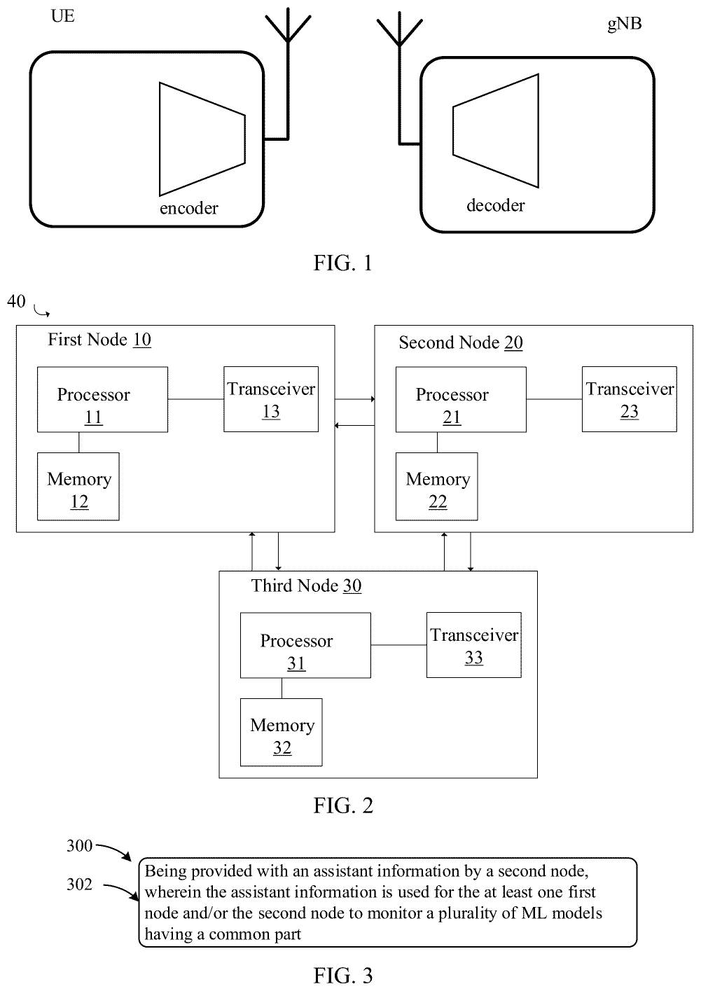

Some embodiments of the present disclosure discuss the CSI feedback enhancement case. FIG. 1 is a schematic diagram illustrating an example of a basic auto-encoder model for enhanced CSI feedback according to an embodiment of the present disclosure. FIG. 1 illustrates that, in some embodiments, a basic model of auto-encoder is shown as follows. The encoder compressed the raw CSI-RS values (in short, raw CSI)/maximum Eigen vector and reports its output to the gNB. The gNB will decompress it. A new CSI report is the CSI report that contains the enhanced CSI feedback by an AI/ML model.

At the UE, the input is compressed and output to the channel. The input of the encoder can be either (maximum) Eigen vectors or channel matrix. The compressed output is the input to the decoder and reconstructed at the gNB side. Several type of ML models of training ML methods are discussed include training at UE side, and delivering the ML model to gNB; training at gNB side, and delivering the model to the UE; joint training by both UE and gNB, separate training at UE and gNB. Some embodiments of the present disclosure mainly discuss joint training by both UE and gNB.

FIG. 2 illustrates that, in some embodiments, at least one first node 10 such as at least one user equipment (UE), and a second node 20 such as base station (e.g., gNB) 20, and at least one first node 30 such as at least one user equipment (UE) for communication in a communication network system 40 according to an embodiment of the present disclosure are provided. The communication network system 40 includes at least one first node 10 such as at least one user equipment (UE), and a second node 20 such as base station (e.g., gNB) 20, and at least one first node 30 such as at least one user equipment (UE). The at least one first node 10 may include a memory 12, a transceiver 13, and a processor 11 coupled to the memory 12 and the transceiver 13. The at least second first node 20 may include a memory 22, a transceiver 23, and a processor 21 coupled to the memory 22 and the transceiver 23. The at least one third node 30 may include a memory 32, a transceiver 33, and a processor 31 coupled to the memory 32 and the transceiver 33. The processor 11, 21, or 31 may be configured to implement proposed functions, procedures and/or methods described in this description. Layers of radio interface protocol may be implemented in the processor 11, 21, or 31. The memory 12, 22, or 32 is operatively coupled with the processor 11, 21, or 31 and stores a variety of information to operate the processor 11, 21, or 31. The transceiver 13, 23, or 33 is operatively coupled with the processor 11, 21, or 31, and the transceiver 13, 23, or 33 transmits and/or receives a radio signal.

The processor 11, 21, or 31 may include application-specific integrated circuit (ASIC), other chipset, logic circuit and/or data processing device. The memory 12, 22, or 32 may include read-only memory (ROM), random access memory (RAM), flash memory, memory card, storage medium and/or other storage device. The transceiver 13, 23, or 33 may include baseband circuitry to process radio frequency signals. When the embodiments are implemented in software, the techniques described herein can be implemented with modules (e.g., procedures, functions, and so on) that perform the functions described herein. The modules can be stored in the memory 12, 22, or 32 and executed by the processor 11, 21, or 31. The memory 12, 22, or 32 can be implemented within the processor 11, 21, or 31 or external to the processor 11, 21, or 31 in which case those can be communicatively coupled to the processor 11, 21, or 31 via various means as is known in the art.

In some embodiments, the processor 11 is provided with an assistant information by the second node 20, wherein the assistant information is used for the processor 11 and/or the second node 20 to monitor a plurality of ML models having a common part. This can solve the issues in the prior art, ease management of a plurality of ML models with a common part, provide methods of monitoring of a plurality of ML models with a common part, reduce system signaling overhead, provide a good communication performance, and/or provide high reliability.

In some embodiments, the processor 21 is used to configure an assistant information to the first node 10 and the at least one third node 30, wherein the assistant information is used for the processor 21 and/or the first node 10 and the at least one third node 30 to monitor a plurality of ML models having a common part. This can solve the issues in the prior art, reduce a management of a plurality of ML models with a common part, provide methods of monitoring of a plurality of ML models with a common part, reduce system overhead, provide a good communication performance, and/or provide high reliability.

FIG. 3 illustrates a method 300 for being configured with a machine learning (ML) model monitoring by at least one first node according to an embodiment of the present disclosure. In some embodiments, the method 300 includes: a block 302, being provided with an assistant information by a second node, wherein the assistant information is used for the at least one first node and/or the second node to monitor a plurality of ML models having a common part. This can solve the issues in the prior art, ease a management of a plurality of ML models with a common part, provide methods of monitoring of a plurality of ML models with a common part, reduce system signaling overhead, provide a good communication performance, and/or provide high reliability

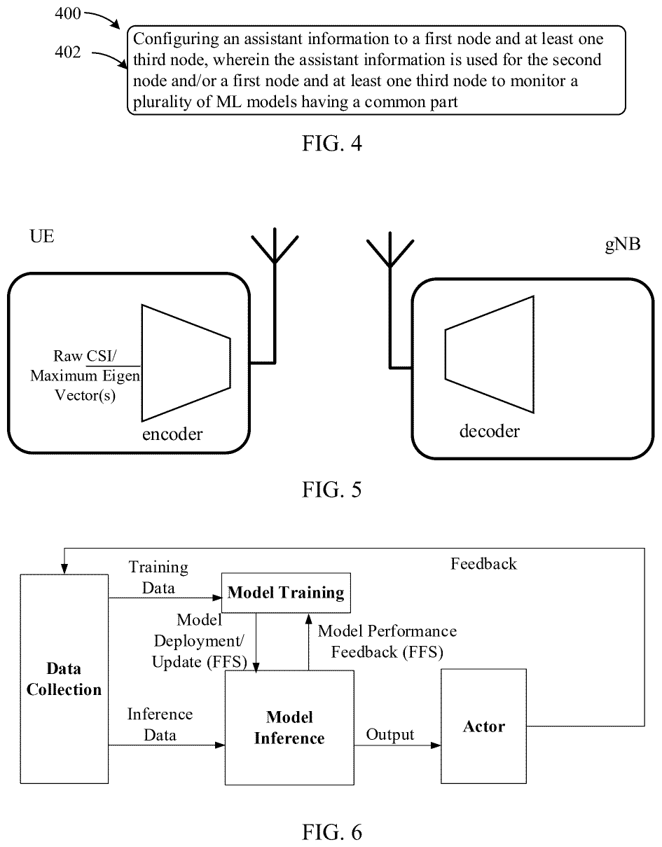

FIG. 4 illustrates a method 400 for configuring an ML model monitoring performed by a second node according to an embodiment of the present disclosure. In some embodiments, the method 400 includes: a block 402, configuring an assistant information to a first node and at least one third node, wherein the assistant information is used for the second node and/or a first node and at least one third node to monitor a plurality of ML models having a common part. This can solve the issues in the prior art, ease management of a plurality of ML models with a common part, provide methods of monitoring of a plurality of ML models with a common part, reduce system signaling overhead, provide a good communication performance, and/or provide high reliability.

FIG. 6 is a schematic diagram illustrating an example of a functional framework of RAN intelligence according to an embodiment of the present disclosure. FIG. 6 illustrates that, in some embodiments, the ML models need to be monitored during model inference. A functional framework of RAN intelligence is provided in RAN3. It can be further modified for RAN1. The ML Model will be monitored after deployment to check whether it works properly. Usually, the ML model performance is compared to criterion. If the ML model does not work properly. The UE will switch to another ML model, or fallback to the non-AI working way. The ML model being monitored will be retrained.

### Embodiment 1

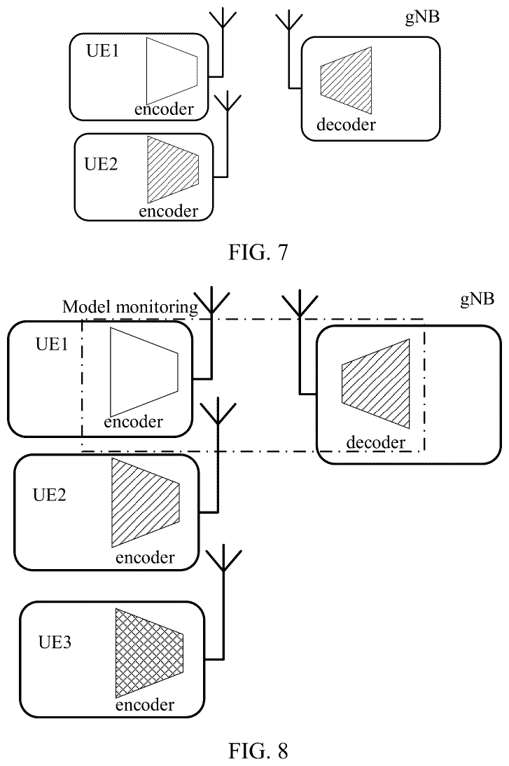

FIG. 7 is a schematic diagram illustrating an example of two UEs with corresponding encoder share a common decoder at the gNB side according to an embodiment of the present disclosure. FIG. 7 illustrates that, as an example, there are several first nodes, which can be UEs, and the one second node, which can be gNB. The encoder of UE 1 and encoder of UE2 shares a common decoder at the gNB. The decoder refers to the CSI reconstruction part and the encoder refers to the CSI generation part.

When the gNB configures the encoders of a plurality of UEs (UE1 and UE2 here), the configuration information should be a broadcast like signal, transmitted downlink. The configuration information is training assistant information.

As an example, the assistant information is contained in DCI 2_0, or in DCI 2_x, or a new UE-group common signaling. It is termed as DCI 2_x, afterwards. As an example, the assistant information comprises at least one of followings: activation/enabling of a deployed ML model, deactivation/disabling of a deployed ML model, activation/enabling of the monitoring of an ML model, deactivation/disabling of the monitoring an ML model, ML model label, and identification information.

In some examples of multiple ML models of different types are supported by UEs. In some examples, in the assistant information, the ML model label can be the type of ML model {“CSIFeedback”, “BeamMangement”, “Positioning”}. This is for the differentiation of the different ML models when several ML models are in a UE. Such that the UE can determine which specific ML model the assistant information is for. The DCI 2_x needs to tell which ML model should be configured. In some examples, it is a two-bit field in DCI 2_x.
{00: “CSIFeedback”,
01: “BeamPrediction Time”,
10: “BeamPredictionSpatial”,
11: “Positioning”}.

“CSIFeedback” denotes the type of ML models for CSI feedback enhancement; “BeamPredictionTime” denotes the type of ML models for beam prediction in time domain; “BeamPredictionSpatial” denotes the ML models for beam prediction in spatial domain; and “Positioning” denotes the ML models for positioning}.

When this field is not configured in the assistant information, or there no such field in the assistant information, by default the assistant information is for the ML model for CSI feedback in UE.

In some examples, the identification information comprises the identification data of ML model part. For example, the identification data can be at least one of the followings: an ID of the ML model common part, an index of the ML model common part, and a name of the ML model common part. In some examples, the ML model common part is for CSI generation. In some examples, the ML model common part is for CSI reconstruction. In some examples, it is a one-bit field in DCI 2_x, where “1” indicates the activation of the related UEs with plurality of ML models. “0” indicates the deactivation of the related plurality of ML models. The activation means after the ML model is deployed, it is activated to work, and enter inference stage. The deactivation means after the ML model has been activated, it is deactivated and stops working or inferencing.

The assistant information is identified by the identification information of the second node. It comprises at least one of the following, cell ID, and RNTI. For example, the UE-group common signaling is scrambled by SFI-RNTI for DCI_2.0, or a new RNTI, for DCI 2_x. The SFI-RNTI is Slot Format Indication Radio Network Temporary Identifier. The RNTI denotes Radio Network Temporary Identifier.

Some examples are about configuration of the ML models which are without a common part. In some examples, the assistant information is for the configuration of a plurality of UEs, each of whom is deployed with an ML model or an ML model part. Some of these ML models or ML model parts are without pairing to a common ML model part. The configuration (providing assistant information with a broadcast-like signaling) comprises at least one of the followings: activation/enabling of a deployed ML model, deactivation/disabling of a deployed ML model, activation/enabling of the monitoring of an ML model, deactivation/disabling of the monitoring an ML model, and identification information.

### Embodiment 2

In another example, the training assistant information, is in SIB/MIB. As an example, the training assistant information comprises at least one of followings: activation/enabling of ML model training, deactivation/disabling of ML model training, and identification information of the second node.

As an example, there can be a field in SIB (x)/MIB. ML-model-activation-monitoring-common {0/1} is provided, where {0} indicates the activation/enabling of ML model monitoring. As an example, it is for CSI feedback. {1} indicates the deactivation/disabling of ML model monitoring. As an example, it is for ML enhanced CSI feedback.

As an example, there can be a field in SIB (x)/MIB. ML-model-activation-common {0/1} is provided, where {0} indicates the activation/enabling of ML model. As an example, it is for ML enhanced CSI feedback. {1} indicates the deactivation/disabling of ML model. As an example, it is for CSI feedback. Such that all the UEs within the current cell can be provided with this information, and this information can be configured for monitoring ML model.

### Embodiment 3

FIG. 8 is a schematic diagram illustrating an example of the monitoring of a two-sided model, which has a common CSI reconstruction part according to an embodiment of the present disclosure. FIG. 9 is a flowchart illustrating an example of monitoring two-sided models, which has a common part CSI reconstruction part according to an embodiment of the present disclosure. FIG. 8 and FIG. 9 illustrate some examples of model monitoring. Some examples for the ML models of CSI feedback with a common part are provided as follows.

The common part can be a common CSI reconstruction part. A UE is running an ML model part for CSI generation. The ML model of this UE and the common part at a gNB is under monitoring. If ML model does not work properly, or, the UE needs to run a model will a different complexity, The model switching will be triggered. In some examples, if one involved UE running an ML model part, it is determined by model monitoring that the ML model malfunctions, all the ML models can be deactivated.

If the UE1 with encoder and the pairing gNB with a common part (decoder) at are determined by model monitoring as malfunction, then the encoder at UE1 will be deactivated, and the UE1 will be switched to another ML model or fall back to a non-AI working way. At the same time, the common part at gNB will be deactivated and the other related UE. The encoder or the decoder (common model part) can be retrained, after deactivation. Each paired one with the common part will be deactivated. The deactivation information is contained in a broadcast-like signaling which be a DCI 2_x.

If some involved UEs who are paired with common ML model part in the gNB, are determined as the ML model malfunctions by model monitoring, the ML models will be deactivated. The deactivation is a contained in a broadcast-like signaling.

In some examples, the number of some involved UEs can be a natural number, or percentage. For example, if 20% the involved UEs whose deployed ML models are indicated as malfunction by model monitoring within a time window, all the UEs whose encoders are paired with a common ML model part will be deactivated. The deactivation is a contained in a broadcast-like signaling. And the common model part at the gNB will be deactivated either.

In some examples, the time window is configured to the involved UE by gNB by RRC signalling/MAC-CE. In some examples, the time window is reported to the gNB by the involved UE.

If all encoders involved UEs paired with the common ML model part at gNB, is determined that the ML model malfunctions by model monitoring within a time window, all the ML models will be deactivated. The deactivation information is a contained in a broadcast-like signaling. In some examples, the time window is configured to the involved UE by gNB by RRC signaling/MAC-CE. In some examples, the time window is reported to the gNB by the involved UE.

### Embodiment 4

In some examples, for model selection, if there is one (backup) ML Model, select this model, elseif there is no back up model, fall back to the non-AI working way and/or elseif there is more than one ML model, choose one ML model randomly.

In some examples, for model selection, if there is one (backup) ML Model, select this model, elseif there is no back up model, fall back to the non-AI working way, and/or elseif there is more than one ML model, choose the ML model with high priority.

The priority is decided by at least one of following factors. For example, the UE prefers low complexity model, then the model with low complexity come first. The complexity can be at least one of the followings, for example, FLOPs, model size, the number of model parameters, pre-processing overhead/complexity, post-processing overhead/complexity. A generalized model or a scenario-specific model (a non-generalized model). In some examples, if a UE prefer a generalized model, the ML model for CSI feedback with a common part comes first. The ML model for CSI feedback with a common part, can be seemed as a special kind of generalized model. In some examples, if a UE prefer a scenario-specific model, the scenario-specific model comes first. The factor for priority may also include power consumption, inference delay, whether the model can be post-processed/pre-processed, and/or whether the model can be fine-tuned.

UE preference (UE report):

In some examples, the priority of ML model is determined by UE report. The UE reports its preference during initial access in UE capability report.

The gNB configurations:

The gNB may configure the priority of ML model selection by RRC/MAC-CE/a DCI field. If the UE does not report any preference, or the gNB does not configure any priority for model selection, the UE or gNB will select one ML model randomly, if there are more than one backup ML models to select.

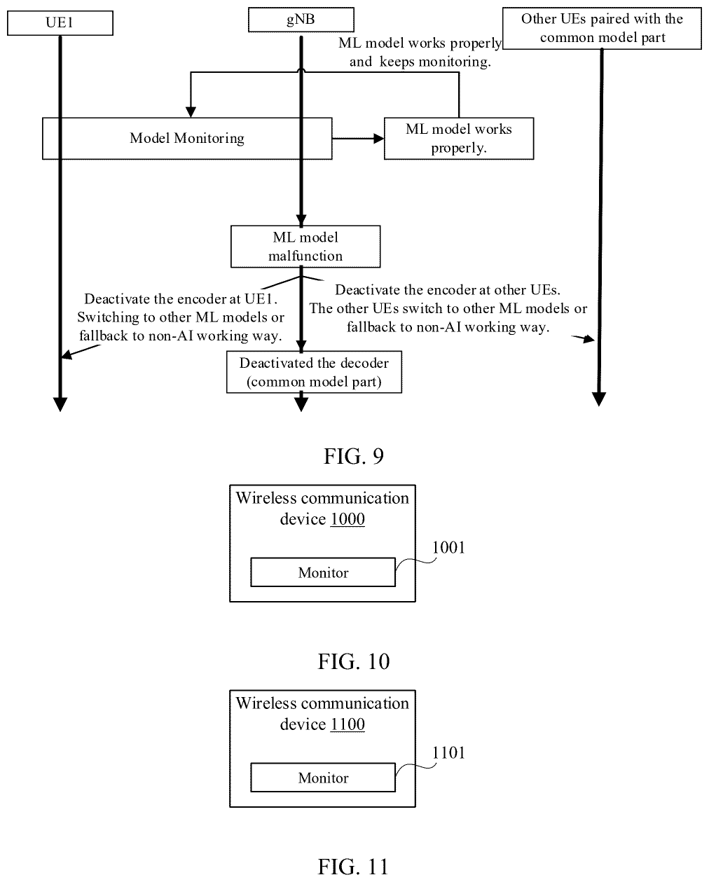

FIG. 10 is a block diagram of a communication device 1000 according to an embodiment of the present disclosure. The communication device 1000 may be a first node such as a UE. The second node can be a base station. The communication device 1000 includes a monitor 1001 used to be provided with an assistant information by a second node, wherein the assistant information is used for the at least one first node and/or the second node to monitor a plurality of ML models having a common part.

FIG. 11 is a block diagram of a communication device 1100 according to an embodiment of the present disclosure. The communication device 1100 may be a second node such as a base station. A first node and a third mode can a UE. The communication device 1100 includes a monitor 1101 used to configure an assistant information to a first node and at least one third node, wherein the assistant information is used for the second node and/or a first node and at least one third node to monitor a plurality of ML models having a common part.

In some examples, the at least one first node is a user equipment (UE), the second node is a base station, at least one third node is at least one another UE, an encoder of the UE and an encoder of the at least one another UE share a common decoder at the base station, the encoder of the UE and the encoder of the at least one another UE refer to one of a channel state information (CSI) generation part and a CSI reconstruction part, and the common decoder of the base station refers to the other of the CSI generation part and the CSI reconstruction part. In some examples, the assistant information is contained in a UE-group common signaling or a broadcast signaling, which is contained in a downlink control information (DCI) 2_0 or a DCI 2_x, or the assistant information is contained in a system information block (SIB) and/or a master information block (MIB).

In some examples, the assistant information comprises at least one of the followings: an activation/enabling of ML model monitoring, a deactivation/disabling of ML model monitoring, an activation/enabling of a deployed ML model, a deactivation/disabling of a deployed ML model, an ML model label, and an identification information. In some examples, an activation/enabling of ML model, a deactivation/disabling of ML model, and/or the activation/enabling of ML model monitoring and the deactivation/disabling of ML model monitoring are DCI fields in the DCI 2_0 or a DCI 2_x. In some examples, the assistant information has a field to indicate each ML model label for identifying different types of the ML models, or when the field is not configured in the assistant information or there is none of the field in the assistant information, the assistant information is by default for at least one of the ML models for CSI generation parts in the at least one first node and the at least one third node.

In some examples, the identification information comprises at least one of the followings: a cell identifier (ID) or a radio network temporary identifier (RNTI), where the UE-group common signaling is scrambled by a slot format indication radio network temporary identifier (SFI-RNTI) for the DCI_2.0 or a new RNTI for the DCI 2_x. In some examples, the identification information comprises an identification data of an ML model part comprising at least one of the followings: an ID of an ML model common part, an index of the ML model common part, a name of the ML model common part. In some examples, the ML model common part is for an ML model common CSI generation part or an ML model CSI reconstruction part.

In some examples, when more than one of the ML models are without a common part, the assistant information comprises at least one of the followings: an activation/enabling of a deployed ML model, the deactivation/disabling of the deployed ML model, the activation/enabling of ML model monitoring, the deactivation/disabling of ML model monitoring, the ML model label, and the identification information. In some examples, for the ML models with a common CSI reconstruction part, if at least one of the at least one first node and at least one third node is running an ML model part for CSI generation, the ML model of the at least one of the at least one first node and the at least one third node and the common part is under monitoring. In some examples, for the ML models with the common CSI reconstruction part, if the ML model does not work properly or the at least one of the at least one first node and at least one third node needs to run a model with a different complexity, the at least one of the at least one first node and the at least one third node, and/or the second node triggers a model switching.

In some examples, if at least one of the running ML model parts running in at least involved one of the at least one first node and at least one third node, paired a common ML model part, is determined as ML model malfunctions by model monitoring, all involved ones or all of the ML models are deactivated. In some examples, the at least one of the running ML model parts running in at least involved one of the at least one first node and the at least one third node, paired with a common ML model part, is determined as ML model malfunctions by model monitoring with a time window, and the time window is configured to the at least involved one of the at least one first node and the at least one third node by the second node through by a radio resource configuration (RRC) signaling or a media access control-control element (MAC-CE), or the time window is reported to the second node by the at least involved one of the at least one first node and at least one third node. In some examples, ML model parts in the at least one first node and the at least one third node and/or the common part are retrained or re-monitored after deactivation. In some examples, for model selection, if there is one backup ML model, at least one of the at least one first node, the second node, and the at least one third node select the one ML model; if there is no backup ML model, the at least one of the at least one first node, the second node, and the at least one third node falls back to a non-artificial intelligence (AI) working way, or if there is more than one backup ML model, the at least one of the at least one first node, the second node, and the at least one third node chooses one backup ML model randomly or chooses an backup ML model with high priority.

In some examples, a priority of an ML model is decided by at least one of following factors: a complexity of the ML model comprising floating point operations per second (FLOPS), a model size, a number of model parameters, a pre-processing overhead/complexity, a post-processing overhead/complexity, a generalized model, a scenario-specific model, a power consumption, an inference delay, a post-process of ML model, a pre-process of ML model, or a fine-tune of the ML model. In some examples, a priority of the ML model is decided by a report of the at least one of the at least one first node, the second node, and the at least one third node. In some examples, at least one of the at least one first node and the at least one third node reports its preference during an initial access in a capability report, the second node configures the priority of the ML model by an RRC signaling, an MAC-CE, or a DCI field, or if none of the at least one first node, the second node, and the at least one third node decides the priority of the ML model, the at least one of the at least one first node, the second node, and the at least one third node selects one ML model randomly if there are more than one ML model to select.

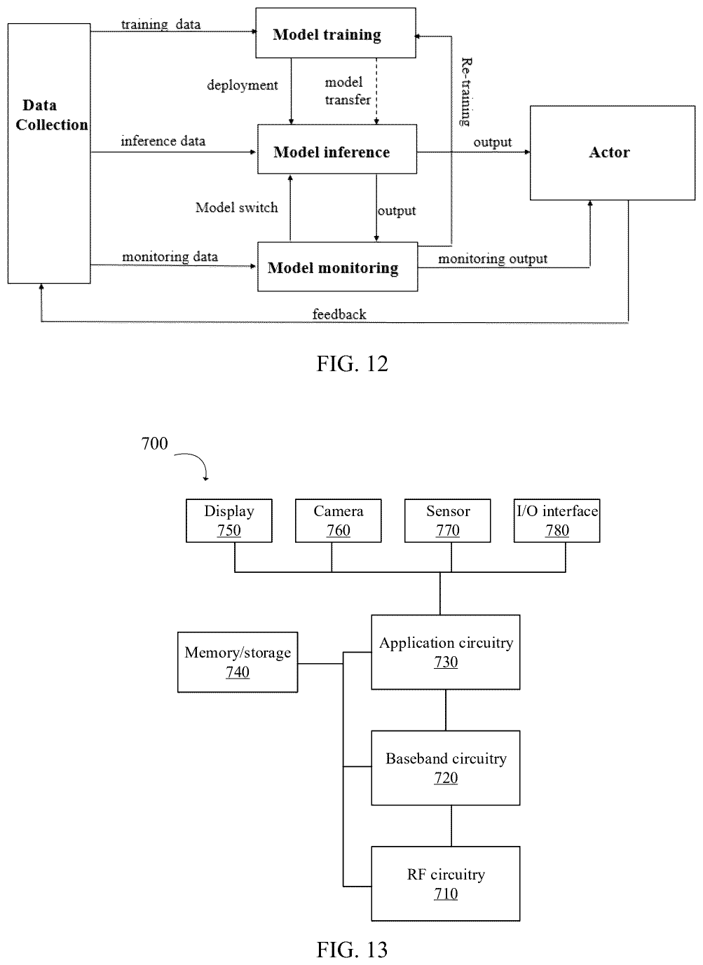

In some examples, the general framework including the model monitoring is given as FIG. 12. The model monitoring is added in compared with FIG. 6. The model monitoring can trigger re-training of an ML model. In this example, the model monitoring can trigger some actions, such model updating, model activation, model deactivation fallback and so on. They are performed by the actor. In another example, there is no connection between the actor and the model monitoring in FIG. 12. The actor only performs the action indicated by model inference.

In summary, in some embodiments of this disclosure, a method is provided for the monitoring of a plurality of ML models with a common part. The common part can be either the CSI generation part or the CSI reconstruction part. When the ML model does not work properly it should be switched to another model. For the ML model for CSI feedback with a common part, several methods are provided for the model monitoring and model selection. some embodiments of this disclosure have at least one of the following invention effects: The management overhead of a plurality of ML models with a common part is reduced. The methods of monitoring of a plurality of ML models with a common part are provided.

FIG. 13 is a block diagram of an example system 700 for wireless communication according to an embodiment of the present disclosure. Embodiments described herein may be implemented into the system using any suitably configured hardware and/or software. FIG. 13 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The monitoring of a ML model is not limited to a UE or a gNB. The monitoring can be performed in third node The related signaling and data need to be reported to the third node. The third node can be a UE, a gNB or a server. The methods in the embodiments apply. In this way, the signaling overhead is reduced between the gNB and the UE

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method for being configured with a machine learning (ML) model monitoring by at least one first node, comprising:
being provided with an assistant information by a second node, wherein the assistant information is used for the at least one first node and/or the second node to monitor a plurality of ML models having a common part.

2. The method according to claim 1, wherein the at least one first node is a user equipment (UE), the second node is a base station, at least one third node is at least one another UE, an encoder of the UE and an encoder of the at least one another UE share a common decoder at the base station, the encoder of the UE and the encoder of the at least one another UE refer to one of a channel state information (CSI) generation part and a CSI reconstruction part, and the common decoder of the base station refers to the other of the CSI generation part and the CSI reconstruction part.

3. The method according to claim 1, wherein the assistant information is contained in a UE-group common signaling or a broadcast signaling, which is contained in a downlink control information (DCI) 2_0 or a DCI 2_x, or the assistant information is contained in a system information block (SIB) and/or a master information block (MIB).

4. The method according to claim 1, wherein the assistant information comprises at least one of the followings: an activation/enabling of ML model monitoring, a deactivation/disabling of ML model monitoring, an activation/enabling of a deployed ML model, a deactivation/disabling of a deployed ML model, an ML model label, and an identification information.

5. The method according to claim 4, wherein an activation/enabling of ML model, a deactivation/disabling of ML model, and/or the activation/enabling of ML model monitoring and the deactivation/disabling of ML model monitoring are DCI fields in the DCI 2_0 or a DCI 2_x.

6. The method according to claim 1, wherein the assistant information has a field to indicate each ML model label for identifying different types of the ML models, or when the field is not configured in the assistant information or there is none of the field in the assistant information, the assistant information is by default for at least one of the ML models for CSI generation parts in the at least one first node and the at least one third node.

7. The method according to claim 4, wherein the identification information comprises at least one of the followings: a cell identifier (ID) or a radio network temporary identifier (RNTI), where the UE-group common signaling is scrambled by a slot format indication radio network temporary identifier (SFI-RNTI) for the DCI_2.0 or a new RNTI for the DCI 2_x.

8. The method according to claim 4, wherein the identification information comprises an identification data of an ML model part comprising at least one of the followings: an ID of an ML model common part, an index of the ML model common part, a name of the ML model common part.

9. The method according to claim 8, wherein the ML model common part is for an ML model common CSI generation part or an ML model common CSI reconstruction part.

10. The method according to claim 4, wherein when more than one of the ML models are without a common part, the assistant information comprises at least one of the followings: an activation/enabling of a deployed ML model, the deactivation/disabling of the deployed ML model, the activation/enabling of ML model monitoring, the deactivation/disabling of ML model monitoring, the ML model label, and the identification information.

11. The method according to claim 1, wherein for the ML models with a common CSI reconstruction part, if at least one of the at least one first node and at least one third node is running an ML model part for CSI generation, the ML model of the at least one of the at least one first node and the at least one third node and the common part is under monitoring.

12. The method according to claim 11, wherein for the ML models with the common CSI reconstruction part, if the ML model does not work properly or the at least one of the at least one first node and at least one third node needs to run a model with a different complexity, the at least one of the at least one first node and the at least one third node, and/or the second node triggers a model switching.

13. The method according to claim 11, wherein if at least one of the running ML model parts running in at least involved one of the at least one first node and at least one third node, paired a common ML model part, is determined as ML model malfunctions by model monitoring, all involved ones or all of the ML models are deactivated.

14. The method according to claim 13, wherein the at least one of the running ML model parts running in at least involved one of the at least one first node and the at least one third node, paired with a common ML model part, is determined as ML model malfunctions by model monitoring with a time window, and the time window is configured to the at least involved one of the at least one first node and the at least one third node by the second node through by a radio resource configuration (RRC) signaling or a media access control-control element (MAC-CE), or the time window is reported to the second node by the at least involved one of the at least one first node and at least one third node.

15. The method according to claim 13, wherein ML model parts in the at least one first node and the at least one third node and/or the common part are retrained or re-monitored after deactivation.

16. The method according to claim 2, wherein for model selection, if there is one backup ML model, at least one of the at least one first node, the second node, and the at least one third node select the one ML model; if there is no backup ML model, the at least one of the at least one first node, the second node, and the at least one third node falls back to a non-artificial intelligence (AI) working way, or if there is more than one backup ML model, the at least one of the at least one first node, the second node, and the at least one third node chooses one backup ML model randomly or chooses a backup ML model with high priority.

17. The method according to claim 16, wherein a priority of an ML model is decided by at least one of following factors:
a complexity of the ML model comprising floating point operations per second (FLOPS), a model size, a number of model parameters, a pre-processing overhead/complexity, a post-processing overhead/complexity, a generalized model, a scenario-specific model, a power consumption, an inference delay, a post-process of ML model, a pre-process of ML model, or a fine-tune of the ML model.

18-19. (canceled)

20. A method for configuring an ML model monitoring performed by a second node, comprising:
configuring an assistant information to a first node and at least one third node, wherein the assistant information is used for the second node and/or a first node and at least one third node to monitor a plurality of ML models having a common part.

21. A first node, comprising:
a memory;
a transceiver; and
a processor coupled to the memory and the transceiver;
wherein the processor is configured to execute a method for being configured with a machine learning (ML) model monitoring, comprising:
being provided with an assistant information by a second node, wherein the assistant information is used for the at least one first node and/or the second node to monitor a plurality of ML models having a common part.

22. (canceled)

23. The first node according to claim 21, wherein the assistant information is contained in a UE-group common signaling or a broadcast signaling, which is contained in a downlink control information (DCI) 2_0 or a DCI 2_x, or the assistant information is contained in a system information block (SIB) and/or a master information block (MIB).
